(19) United States
(12) Patent Application Publication
(10) Pub. No.: US 2008/0143128 A1
(43) Pub. Date: Jun. 19, 2008

(54) Hand manipulated pusher apparatus with adjustably spaced teeth for cleaning uneven corrugated surfaces

(76) Inventors: Mark J. Kuhns, Northampton, PA (US); Lynn Peters, Walnutport, PA (US)

Correspondence Address: SANFORD J. PILTCH, ESQ., 1132 HAMILTON STREET, SUITE 201, ALLENTOWN, PA, 18101, US

(21) Appl. No.: 12/072,351

(22) Filed: Feb. 25, 2008

Related U.S. Application Data
(63) Continuation-in-part of application No. 10/939,647, filed on Sep. 13, 2004, now abandoned.

(51) Int. Cl. A01B 1/22

(52) U.S. Cl. 294/51

(57) ABSTRACT

A manually manipulated shovel-like device for cleaning corrugated floors along the bottom of refrigerated containers and trailers having a blade, an elongate handle extending from the proximal end of the blade, and a plurality of elongate cleaning teeth extending perpendicularly from the opposed distal end of the blade. Each of the cleaning teeth are individually slidably adjustable in both the lateral and the perpendicular directions with respect to the distal edge of the blade to enable the device to clean corrugated floors having unequally spaced apart corrugations of varying depths and widths, joints between sections of corrugated panels, and uncorrugated sections near walls of the container. The teeth are also individually removable, reversible and replaceable from their respective positions on the blade so that teeth of various geometrical configurations and functional features may be used, including teeth tapered to a narrower distal tip, teeth of generally uniform width, and teeth having chisel-pointed edges. The blade may optionally be curved to have a concave front side, and further have frontwardly extending sidewalls.

### CROSS-REFERENCE TO RELATED APPLICATION

This application is a continuation-in-part of U.S. patent application Ser. No. 10/939,647, filed Sep. 13, 2004, now abandoned.

### BACKGROUND OF THE INVENTION

The present invention relates generally to the field of manually manipulated cleaning devices for the specific use of cleaning the channels or recessed corrugations in uneven corrugated floors along the bottom of refrigerated trailers, vans, and large transport containers. More particularly, the present invention relates to an apparatus for cleaning the plurality of channels in a corrugated floor of a refrigerated trailer having a handle, a pusher blade, and a plurality of laterally and vertically adjustable teeth or fingers arrayed along the bottom edge of the pusher blade.

The transportation of perishable commodities, produce, and foodstuffs in insulated refrigerated bodies such as trucks, trailers, and containers is prevalent around the world. The floors of these bodies are typically corrugated both to enhance the strength of the flooring to be able to support heavy loads of goods, as well as loading and unloading equipment, and to enable the circulation of chilled air beneath the cargo to maximize the preservative benefits of such refrigeration. Often, in a truckload of perishable food or produce, the weight combined with the shifting around of the cargo during transport will cause some of the produce on the bottom layer to be crushed on the corrugated floor, both on top of and into the recessed channels. These remnants of the refrigerated cargo (sometimes called mash in the industry) remain as residue in the trailer after the usable cargo is unloaded. This residue must be removed before taking on a fresh load.

Corrugated floor surfaces of refrigerated bodies are difficult to clean, particularly when the channels become encrusted or caked with mash and ice. Standard shovels are inadequate for the task because the shovel blade is typically wider than the channel and cannot clean inside the recessed channels. Implements such as rakes or ice chippers having a plurality of fixed, regularly spaced teeth or tines are also not suitable because in most instances the regularly spaced teeth will not correspond with or fit into the recessed channels or corrugations. The cleaning apparatus of the present invention is particularly designed for use in cleaning up and removing this mash from the corrugated floor, the apparatus being able both to clear any load mash on top of the channels and to clean and push load mash from within the recessed channels in the corrugated floor.

Various manufacturers make corrugated floors for refrigerated bodies. The channels are generally parallel and run the length of the floor. The distance between channels of a corrugation may vary considerably from one container to another, and from one manufacturer to another, because of the lack of manufacturing standards for such flooring. Also, although the recessed corrugations in pre-fabricated sheets are often regularly spaced, variations in spacing may occur across a particular corrugated floor because most floors, especially in large trailers or containers, are fabricated from multiple one foot or two foot wide pre-fabricated segments joined together. At the seams, there is an overlap of the floor segments, and therefore, the channel depth at or near the overlap is typically less than it is for the other channels of the corrugated floor. Additionally, the spacing between channels on either side of a joint can be closer or farther apart than that between the channels on the remainder of the floor. Further, near the edge of the floor, i.e., at the wall of the container or trailer, there are typically no channels; instead there is a wider segment of uncorrugated flooring immediately adjacent to the trailer or container wall.

Single tined implements have been partially effective in cleaning corrugated surfaces, but the process of cleaning each recessed channel or corrugation individually is excessively time consuming. Moreover, there is a tendency for debris removed from one channel to fall into an adjacent, previously cleaned channel.

An attempt to solve this problem is disclosed in U.S. Pat. No. 4,229,032 [Murphy], which describes a hand manipulated pusher blade having a plurality of uniformly spaced downwardly extending teeth protruding a fixed vertical distance below the pusher blade. The pusher blade is rotatable in and out of position over the plurality of teeth to provide a flat-bladed shovel-like action when engaged. The teeth are held in an equally spaced array between the opposite sides of the device by a series of identical cooperating springs, and all of the teeth must be of identical width for the device to function as intended. As illustrated and disclosed, the distal ends of the teeth are squared off and chisel-pointed with the particular purpose of scraping ice from within the corrugated channels. Teeth can be added or removed to accommodate different corrugated floors, but in all cases, the tooth spacing is intended to remain uniform.

Shortcomings of the Murphy device render it unable to clean a large percentage of the corrugated floors for which it is intended to be used. One problem with the Murphy device is that equidistantly spaced teeth, a central feature of the disclosed device, cannot accommodate a floor with non-uniformly spaced corrugations, as occurs at a joint between floor segments or near a wall. Another problem is that the teeth are all of equal vertical depth and therefore the device cannot be used to simultaneously clean channels of varying depths or sections of corrugated flooring having a combination of channels and flat surfaces such as may exist adjacent to a wall of the container. An additional problem is that if the device is used to clean the debris of fungible goods and not just ice, the springs may tend to become caked with debris resulting in the misalignment of teeth at the bottom of the pusher blade. A further problem is that the squared-off distal ends of the teeth will not be capable of cleaning to the bottom of the channels (or of cleaning both the bottoms and the sides of the channels) of most modern corrugated flooring which typically have channels that narrow or taper inwardly towards the respective bottoms.

While the device just described is the only known implement for clearing corrugated trailer and container floors, a number of tools having similar configurations have been used in the agricultural field. U.S. Pat. No. 4,901,801 [Popivalo] describes a hand implement having a number of equidistantly spaced teeth extending downward and outward from a handle and oppositely extending blade useful for a number of earth-working tasks. The primary tasks described are cultivating the earth by utilizing either the blade or the teeth to extend a uniform depth beneath the surface to either extract the weed or to cut the weed off from its roots below the surface. For either task, neither the blade nor any of the teeth are adjustable.

A much older cultivating device is described in U.S. Pat. No. 1,697,572 [Perham] in which one or more yokes carrying a number of grouped teeth may be utilized to created furrows in the ground. This device utilizes a number of downwardly extending teeth, or earth-working implements that are attached to an angle iron with a number of horizontally extending slots through which the teeth are mounted to the implement (teeth) supporting bars. Although the teeth can be laterally adjusted for position, there is no means for adjusting the inward-outward extension described. In fact, if the vertical adjustment were to be permitted, the depth of penetration of the implements would be compromised and the furrows would be of uneven depths defeating the very purpose of the ganged earth-working implements on a single support.

Another related device is that described in U.S. Pat. No. 5,417,044 [Russo] in which a series of uniform length teeth extend outward along one side of a basket, each tooth being attached to the wire mesh of the basket. This implement is used for muck raking and carrying the excrement to a suitable disposal site. No adjustments for the teeth or scrapers are described as it appears that the length of the teeth or tines is all that is needed to scrape beneath the excreted droppings and slide or flip them into the basket for carrying away.

A number of ground scrapping devices were uncovered that have a certain similarity to the present invention, but do not exhibit the capability to match the scrapping implements to the underlying surfaces. U.S. Pat. No. 4,865,372 [Gabriel] describes a back strain relief shovel with a saw-tooth scrapping edge. The back saving device is the incorporation of rollers on the back/underside of the shovel, rearward of the scrapping blade, permitting the transport of loads without lifting the shovel. There is no mention of any adjustment in the tooth spacing or extension of the scrapping blade.

Much earlier hand-manipulated surface scrapping implements are described in U.S. Pat. No. 1,008,382 [Sourek] and U.S. Pat. No. 2,236,093 [Friend] in which individual teeth or tines contact the underlying surface for scrapping that surface as the tool is pulled along above. Neither of these devices describes any tooth adjustment of any kind other than the substitution of other scrapping teeth in the identical location in the Friend scraper tool. Another very early road scrapping device in U.S. Pat. No. 7,340 [Davis] utilized a number of identical teeth attached across the open front of large scoop having two rearwardly extending handles. The teeth are attached in a uniformly spaced array and are neither adjustable laterally or inward or outward of the scoop lip or scrapping blade. The teeth form an extension to the scoop scrapping blade and are fixedly mounted to holes cut into the extension of the scoop. It is only the extension to the scoop, by adjusting its sidewalls relative to the scoop sidewalls that may be utilized to adjust the pitch of the extension to the ground and to the scoop.

A more recent advent, and on a much larger scale, was the introduction of teeth extending outward from a digging bucket cutting edge on, perhaps, a backhoe machine. U.S. Pat. No. 3,550,293 [Helton] describes the augmentation of the bucket cutting edge with one or more teeth bolted to and through the bucket sidewall and extending outward beyond the cutting edge. Each tooth is bolted within an attachment point and guide for retaining the teeth perpendicular to the cutting edge when in use. In the event that the teeth are not in use, an adaptor is bolted into the guide, as shown in FIG. 2, to retain the attachment point and guide for the extending teeth in alignment and free of debris for the next time they are used. There is no mention of a mechanism for retraction of one or more teeth, or of lateral movement for adjusting the cutting or working edge of the bucket.

In completing the study of scrapping implements, we must also address the scrapping of cooking surfaces, such as outdoor cooking grilles. One cooking grate cleaning implement is described in U.S. Pat. No. 7,720,071 [Hall] in which any number of teeth may be positioned and attached within a laterally extending slot on the head plate. Each tooth is individually attached in a position relative to the spacing of the grille staves to be cleaned. Once positioned in the appropriate lateral spacing the teeth may be used to scrape against the grille staves to clear away burned on food and other debris. There does not appear to be any suggestion that the teeth are adjustable out of the way by retraction, or of adjusting the penetration depth of any individual tooth. Thus, for the cleaning tool to function properly, each tooth must be attached at its desired lateral (horizontal) position at exactly the same depth of penetration, or extension, from the head plate.

A similar tool for cleaning barbeque grilles is described in U.S. Pat. No. 5,255,406 [Rood] which also provides for the lateral (horizontal) adjustment of individual scraper teeth. In an alternate embodiment of the Rood grille cleaning implement, individual tooth members have an elongated aperture to accommodate vertical adjustment, i.e., depth of penetration into the grille, by moving the tooth up or down so that the extension of that tooth differs from the others. However, no reason is provided for this vertical adjustment in view of the primary function of the cleaning tool contacting the tops of the grille rods.

With the exception of the Rood patent, all of the other tools and implements, when they exhibit laterally adjustable teeth, do not describe any vertical adjustment of the same teeth for any reason. In fact, other than Rood, all of the other tools and implements would not operate as intended if a vertical adjustment were incorporated. Further, even the Rood cleaning implement does not provide for the adjustability of outward and downwardly extending appendages of differing geometries to clean away debris from a recess that is irregularly shaped and/or wider than a single appendage, or from an extended flat section immediately adjacent to a recess that may be of a slightly lesser depth or abuts a wall segment.

Therefore, it is an object of the present invention to provide a manually manipulated pusher apparatus for cleaning corrugated floors having cleaning teeth that are individually adjustable in the lateral direction so that they need not be equidistantly spaced. It is a further object of the present invention to provide a corrugated floor cleaning apparatus having cleaning teeth that are individually adjustable in the vertical direction, perpendicular to the pusher blade, so that they can accommodate corrugated floors with joints, channels of various depths, and non-corrugated sections near container walls by partial or full retraction or extension. It is also an object of the present invention to be able to utilize multiple teeth to clean a recessed corrugation with the cleaning edges of the teeth matching the geometry of the bottom and sidewall of the recess corrugation.

It is yet an additional object of the present invention to provide a corrugated floor cleaning apparatus having removable and replaceable teeth so that the geometry and cleaning edges of the teeth may be varied to match the shape of the corrugated floor and the type of debris to be cleaned. It is another object of the present invention to provide a corrugated floor cleaning apparatus that is not impaired in its operation by exposure to the very debris (e.g., mash) that it is intended to remove. It is still yet another object of the present invention to provide a corrugated floor cleaning apparatus that can be also used as a standard flat-bladed shovel.

Other objects will appear hereinafter.

### SUMMARY OF THE INVENTION

The present invention is a manually manipulated pusher apparatus specifically adapted for cleaning the corrugated flooring used in refrigerated containers, vans and trailers, or other transport vehicles. The apparatus includes a pusher blade having a variable number of elongate cleaning appendages or teeth arrayed along the distal edge thereof with the capability of full retraction or partial or full extension vertically downward therefrom, each tooth being individually adjustable in both the lateral and vertical directions to accommodate recessed corrugations of non-uniform spacing and depth and flat flooring sections. The pusher blade is operated by a handle affixed to the proximal end thereof.

With the cleaning appendages or teeth extended, the apparatus is capable of clearing load mash from inside of and on top of corrugated floor channels simultaneously. If desired, all of the teeth can be retracted and the apparatus can be used as a regular flat-bladed shovel or pusher to clear load mash just from the floor surface at the top of the recessed corrugations or channels before readjusting the teeth to their partial or fully extended positions to clear mash from within the recessed channels.

Each one of the cleaning appendages, teeth or fingers is tapered toward a first end thereof and has a rounded tip to accommodate the inwardly tapering channels of most corrugated flooring. The opposite or second ends of the teeth are substantially rectangular in shape with rounded corners to provide a flatter surface for scrapping the bottom of the recesses, the connection joints between sections of the corrugated floor, and the uncorrugated sections along the sidewalls of the container. Moreover, the teeth are replaceable, and therefore cleaning appendages or teeth of variously shaped, tapered sides and end portions may be used singly or together to match the shape of any recessed channel that is used in corrugated flooring.

The position of each tooth is independently adjustable by the loosening and tightening of a positioning and tightening means in the form of a slotted vertical alignment means (carriage bolt) and a cooperating tightening (wing) nut. Each tooth may be vertically adjusted by repositioning the tooth up and down in a vertically oriented slot or channel contained in the tooth and may be laterally adjusted by sliding the tooth and tightening means laterally in a horizontal slot or channel in an edge plate attached to the distal portion of the pusher blade. Each tooth may be reversed in direction so that the rectangular edge of the second end is presented as extending outward from the pusher blade, or the teeth may be adjusted to be only partially extended, or retracted, as compared to other teeth along the blade edge. Any tooth may be removed completely by removing the tightening means from such tooth and detaching the tooth from the apparatus.

The pusher blade may be curved to provide a concave front to allow for the collection of debris from the flooring to be accumulated and pushed out of the rear of the trailer or container. Additionally, the sides of the blade may have frontwardly extending perpendicular sidewalls to retain the debris on the pusher blade instead of allowing excess debris to be pushed off and around the sides thereof. Such sidewalls on the pusher blade may also be used to clear debris from against the sidewalls of the trailer.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a front plan view of the array of teeth along the leading bottom edge of the pusher apparatus of the present invention.

FIG. 2 is a plan view of the pusher apparatus of the present invention with the array of teeth engaged with a continuous corrugated surface having a plurality of uniformly spaced channels or troughs with the shape of the teeth approximately matching the shape of the corrugation channels.

FIG. 3 is a plan view of the pusher apparatus of the present invention with the array of teeth engaged with a continuous corrugated surface spanning a joint in such corrugated surface with the shape of the teeth approximately matching the shape of the corrugation channels and one tooth reversed over the joint to provide a broader aspect for clearing debris.

FIG. 4 is a plan view of the pusher apparatus of the present invention with the array of teeth engaged with a continuous corrugated surface spanning a joint and abutting a wall of such corrugated surface with the shape of the teeth approximately matching the shape of the corrugation channels and several teeth reversed over the joint and along the abutting wall to provide a broader aspect for clearing debris.

FIG. 5 is a front plan view of the array of teeth along the leading bottom edge of the pusher apparatus of the present invention adjusted for a differently spaced array of a plurality of channels or troughs in a corrugated surface with two teeth shown fully retracted.

FIG. 6 is an enlarged view of the circled area of FIG. 1 showing the adjustment and attaching means of the present invention.

FIG. 7 is a partial sectional view of the pusher apparatus of the present invention viewing a single tooth adjustment and attaching means taken along Line 7-7 of FIG. 1.

FIG. 8 is a sectional view of the tooth adjustment and attaching means of the present invention taken along Line 8-8 of FIG. 7.

FIG. 9 is an enlarged view similar to that of FIG. 6 showing the adjustment and attaching means of the present invention with the tooth reversed and the rectangular edge extended.

FIG. 10 is a plan view of the pusher apparatus of the present invention with the array of teeth engaged with a continuous irregularly spaced corrugated surface spanning a joint and abutting a wall of such corrugated surface with the shape of the teeth approximately matching the shape of the corrugation channels and several teeth reversed within the wider channel, over the joint, and along the abutting wall to provide a broader aspect for clearing debris.

### DETAILED DESCRIPTION OF THE PREFERRED EMBODIMENT

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

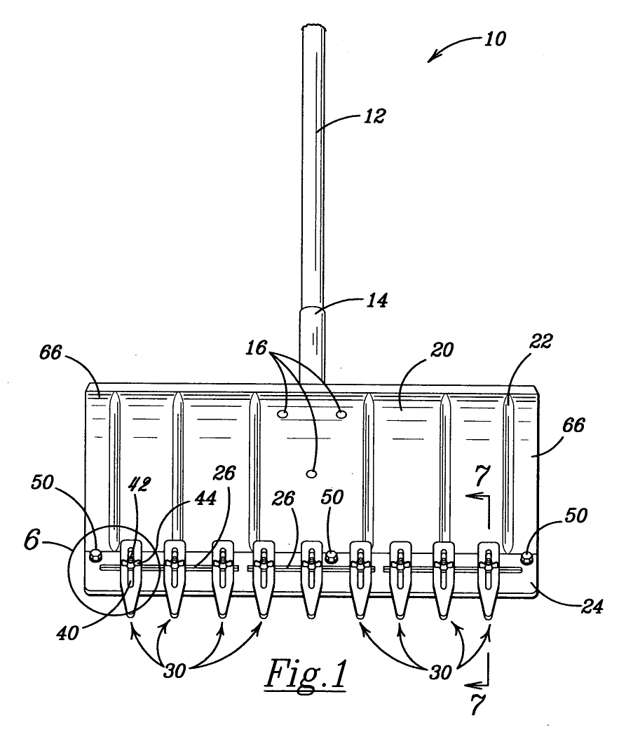

Referring now to the drawings in detail, where like numerals refer to like parts or elements, there is shown in FIG. 1 a front plan view of the pusher apparatus 10 of the present invention. The pusher apparatus 10 includes a handle 12, a blade 20, and an edge plate 24 onto which a plurality of laterally and vertically adjustable cleaning appendages or teeth 30 are arrayed.

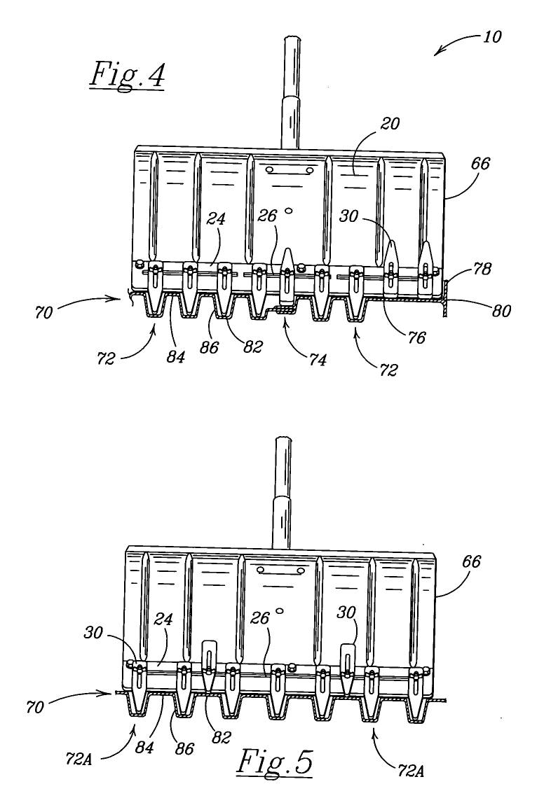

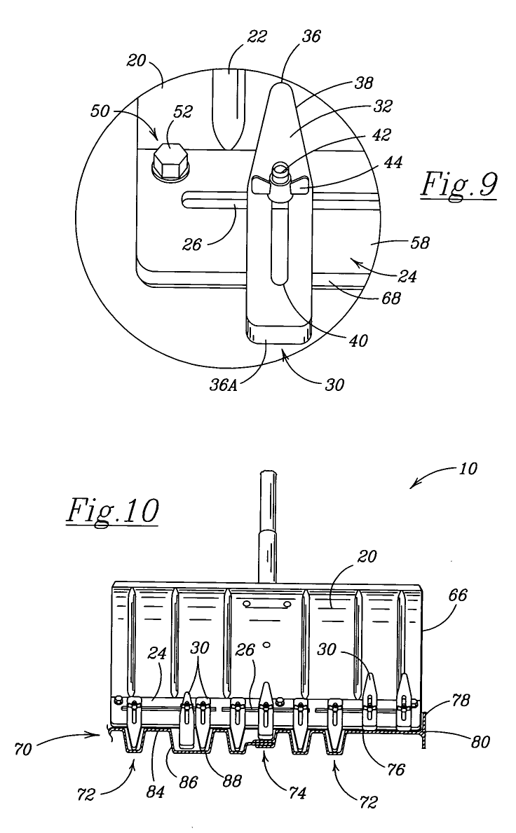

The pusher blade 20 is an essentially planar element, generally rectangular in shape and is preferably formed from a strong material such as galvanized sheet steel, a suitably rigid injection molded plastic, or other similar substantially rigid material. The blade 20 may be slightly curved in cross-section, with a concave front 62 and a convex back 64, as partially illustrated in FIG. 7, the curvature of the blade 20 allowing the debris collected from the floor 70 to be accumulated and pushed out of the rear of the trailer or container. Further, the blade 20 may optionally include reinforcing ribs or corrugations 22 to increase the load bearing and force transmitting capabilities thereof, as the apparatus 10 is used to push debris from a corrugated floor 70. Additionally, the blade 20 may include frontwardly extending perpendicular sidewalls 66, as shown in FIGS. 1, 4, 5, and 10 to retain debris on the blade 20 instead of allowing excess debris to be pushed off and around the sides thereof by newly gathered debris. The optional sidewalls 66 are adapted to the curvature of the blade 20 while remaining perpendicular to the concave front 62 of the blade such that the sidewalls 66 have the capability of cleaning the flat walls 78 of the trailer or container when the apparatus 10 is used at a corner 80 of a section of corrugated floor 70. See FIGS. 4 and 10.

The handle 12 is rigidly fastened to the back 64 of the blade 20 to extend proximally outward therefrom. As illustrated, the cylindrical or tubular handle 12 is insertably secured into a handle mount 14, the mount 14 being fastened to the back 64 of the blade 20 by fastening means 16. The fastening means 16 may comprise bolts, rivets, screws, welds, other mechanical fastening means known in the art, or a combination thereof. Alternatively, the mount 14 may be formed as an integral part of the blade 20. The handle 12 may be made from wood, metal, plastic, or other suitably strong material.

The edge plate 24, having a front face 58 and a rear face 60, is removably mounted to the front 62 of the blade 20, overlapping and extending outwardly from the distal end 68 thereof, as shown in the expanded views of FIGS. 7, 8. The edge plate 24 is secured to the blade 20 by a plurality of fastening means 50 each comprising a through bolt 52, a matching nut 54, a washer 56 mounted on the shaft of the bolt 52 and positioned between the head thereof and front side 58 of the edge plate 24, and a washer 56 mounted on the shaft of the bolt 52 and positioned between the nut 54 and the back 64 of the pusher blade 20. As assembled, a proximal portion of the rear face 60 of the edge plate 24 is flush against a distal portion of the front 62 of the blade 20. The illustrated embodiment shows three fastening means 50 clamping the edge plate 24 to the blade 20, but a different number of fastening means 50 may be used as required to provide adequate stiffness in the interconnection between the pusher blade 20 and the edge plate 24. Because the fastening means 50 are removable, a damaged or worn edge plate 24 may be removed from the blade 20 and replaced, eliminating the need to discard the entire apparatus as long as the blade 20 and handle 12 are in good working condition.

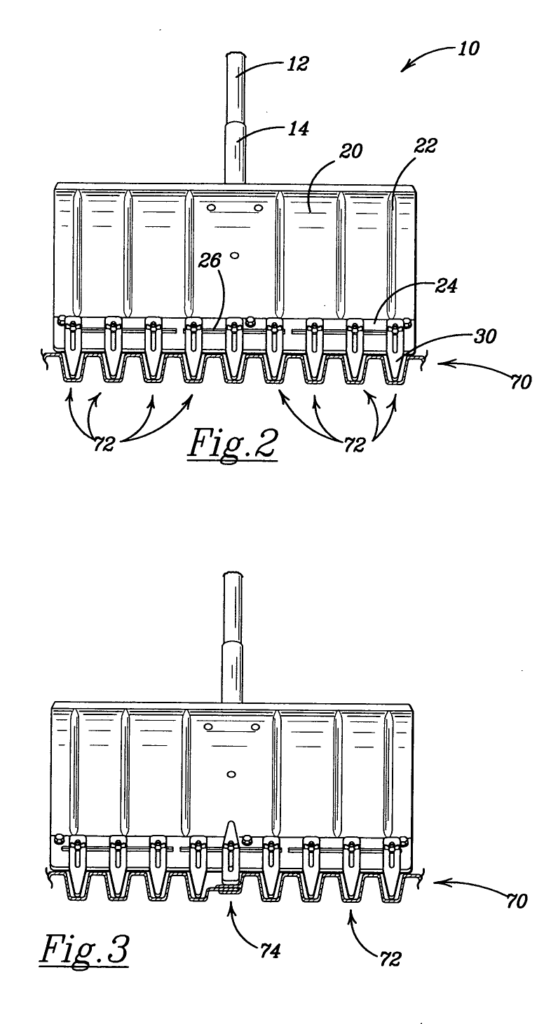

The elongate cleaning appendages or teeth 30, each having a front face 32 and a rear face 34, are adjustably and removably secured to the edge plate 24. Each tooth 30 is secured to be in contact with the front face 58 of the edge plate 24 using a securing means comprising a square-shanked carriage bolt 42 and a matching wing nut 44. A number of generally rectangular lateral positioning channels 26 in the edge plate 24 extend therethrough from the front face 58 to the rear face 60, each channel 26 having a width adapted to snugly receive the square shank 46 of the carriage bolt 42 so that the carriage bolt 42 cannot turn when inserted into any of the laterally extending channels 26. The illustrated embodiments in FIGS. 1-5 and 10 show three lateral positioning channels 26, however a different number of channels 26 may be desired depending upon the width of the blade 20 and thickness of the edge plate 24; a wider blade 20 or thinner edge plate 24 may necessitate a greater number of relatively shorter channels 26 to maintain sufficient strength and stiffness in the edge plate 24.

Each elongate tooth 30 includes a generally rectangular vertical positioning slot 40 extending therethrough from the front face 32 to the back face 34, each slot 40 having a width adapted to snugly receive the square shank 46 of the carriage bolt 42 so that the carriage bolt 42 cannot turn when inserted into the slot 40, and likewise, the tooth 30 cannot rotate about the bolt 42 creating a non-perpendicular relationship to the edge plate 24. When assembled to the edge plate 24, each tooth 30 is secured with at least a proximal portion of the back face 34 of such tooth 30 flush against the front face 58 of the edge plate 24. One carriage bolt 42, in combination with one cooperating wing nut 44, secures each tooth 30. The head 48 of the carriage bolt 42 is positioned adjacent to the rear face 58 of the edge plate 24 with the square shank 46 extending through the lateral positioning channel 26 in the edge plate 24 and through the vertical positioning slot 40 in the tooth 30 with the slot 40 perpendicular to the channel 26. The matching wing nut 44 is screwed onto the threaded end of the carriage bolt 42 protruding outwardly beyond the front face 32 of the tooth 30 to draw the tooth 30 and the edge plate 24 together. Because the square sided shank 46 of the carriage bolt 42 fits snugly into both the lateral positioning channel 26 and the vertical positioning slot 40, the tooth 30 is held in position and cannot rotate with respect to the edge plate 24 or the blade 20. See, FIG. 7. The physical interlock between the rectangular slots 26, 40 and the square carriage bolt shank 46 prevents a tooth 30 from becoming skewed away from its perpendicular orientation when applied to remove debris in a recessed corrugation or channel 72, over a joint in the corrugation 74, or along a wall 78 when the pushing apparatus 10 is being used to clean a corrugated floor 70.

A tooth 30 may be repositioned vertically with respect to the edge plate 24 by loosening the wing nut 44 and then sliding the tooth 30 upwardly or downwardly as constrained by the cooperating vertical positioning slot 40 and the carriage bolt shank 46 to increase or decrease the extension beyond the edge plate 24. Each tooth 30 can be moved from a fully extended position, whereby the tip 36 and the cleaning edges 38 of the first end of tooth 30 are fully exposed for use in cleaning the recessed corrugations 72 of a corrugated floor 70, to a fully retracted position, whereby the tip 36 is withdrawn above the distal edge 68 of the edge plate 24 so that the apparatus 10 provides a flat edge similar to that of a regular square bladed shovel. With all of the teeth 30 fully retracted, the apparatus 10 may be used to clean the top surface 84 of the corrugated floor 70 of large debris before subsequently cleaning the recessed corrugations 72, and may also be used to clean completely flat floors or surfaces.

A tooth 30 may also be reversed in orientation such that the opposite end 36a of the tooth 30 is extended beyond the distal edge 68 of the edge blade 24 providing a rectangular geometric configuration, i.e., a blunter edge, to be applied to the surface to be cleaned. See particularly FIG. 9, and also see FIGS. 3, 4 and 10. The process of reversing a tooth 30 requires the removal of the wing nut 44 from the carriage bolt 42, removal and repositioning of tooth 30 in the orientation with the rectangular edge 36a facing downward, and the reattaching of the wing nut 44 to the bolt 42 to secure the tooth 30 in the reversed position. As before, the physical interlock between the rectangular slots 26, 40 and the square carriage bolt shank 46 prevents a tooth 30 from becoming skewed away from its intended perpendicular orientation when applied to remove debris. With the teeth 30 extended, the apparatus 10 may be used to simultaneously clean the recessed channel or trough bottoms 82 and the recessed sides 86, as well as the corrugation top surfaces 84 of a corrugated floor 70. Adjustment of any of the teeth 30 is easily accomplished, as described above, such that each individual tooth 30 is positioned both laterally and vertically as desired to match the configuration of the floor 70 in regard to both depth and width of recesses and flat sections, with the tooth 30 being resecured in its desired position by tightening the wing nut 44 on the carriage bolt 42.

Each tooth 30 can be vertically positioned independently so that some teeth 30 may be extended vertically more or less than other teeth 30 with respect to the distal end 68 of the edge plate 24, enabling the apparatus to be used to clean corrugated floors 70 having recessed corrugations 72 of differing depths and to clean near the corners or edges 80 of such corrugated floors 70 where there may be no recessed corrugations 72. Refer in this regard to FIG. 3, which shows one tooth 30 reversed to accommodate a joint 74 between two sections of corrugated flooring 70, the joint 74 being substantially flat and having a recess depth less than the other recessed channels or troughs 72 of the floor 70. Refer further to FIG. 4, illustrating one tooth 30 reversed to accommodate a joint 74 and, along the right side, two teeth 30 reversed and fully retracted to accommodate a non-corrugated section 76 of the floor 70 near the corner or edge 80 of the floor 70 in a container or truck. With the teeth 30 optimally adjusted, the apparatus 10 can be used to simultaneously clean the top surfaces 84, the trough sides 86, and the trough bottoms 82 of the channels 72 in a corrugated floor 70. As can readily be seen, a limitless combination of vertical positions of the teeth 30 can be achieved with the apparatus 10.

A tooth 30 may be repositioned laterally with respect to the edge plate 24 by loosening the wing nut 44 and then sliding the tooth 30 along with its cooperating carriage bolt 42 and wing nut 44 laterally as constrained by the cooperating lateral positioning channel 26 and the carriage bolt shank 46. Two teeth 30 can be moved so close together as to be in contact with each other or as far apart as each positioning channel 26 will permit, to enable the apparatus 10 to accommodate corrugated floors 70 having varied or non-uniformly spaced recessed corrugations 72. Refer in this regard to FIG. 5, which illustrates both the non-uniform lateral spacing of teeth 30 to accommodate irregularly spaced recessed corrugations 72A in a floor 70 and the varied vertical positioning of teeth 30 similar to that shown in FIGS. 3, 4. As such, it can be seen that the vertical and lateral position of each tooth 30 can be adjusted independently so that in combination, the various teeth 30 can be situated to enable the apparatus 10 to be used to clean a corrugated floor 70 having virtually any combination of recessed channel or trough depths and spacing patterns.

A tooth 30 may be removed from the edge plate 24, and thus from the apparatus 10, by loosening and removing the wing nut 44, removing the bolt 42 from the slots 26, 40, and then removing the tooth 30 from the edge plate 24. Installation of a tooth 30 is the reverse of the removal. A tooth 30 can therefore be readily removed in order to replace a damaged tooth 30, to remove any number of teeth 30 not needed for a particular cleaning task (although it would be more convenient in that case to simply retract the unneeded teeth 30 as previously described), or to replace a tooth 30 with one having a tip 36 and cleaning edges 38 of a different configuration or functional features. When installing any tooth 30, that tooth can be oriented with either the tapered tip 36, or the rectangular tip 36a, extending outward away from the blade 20.

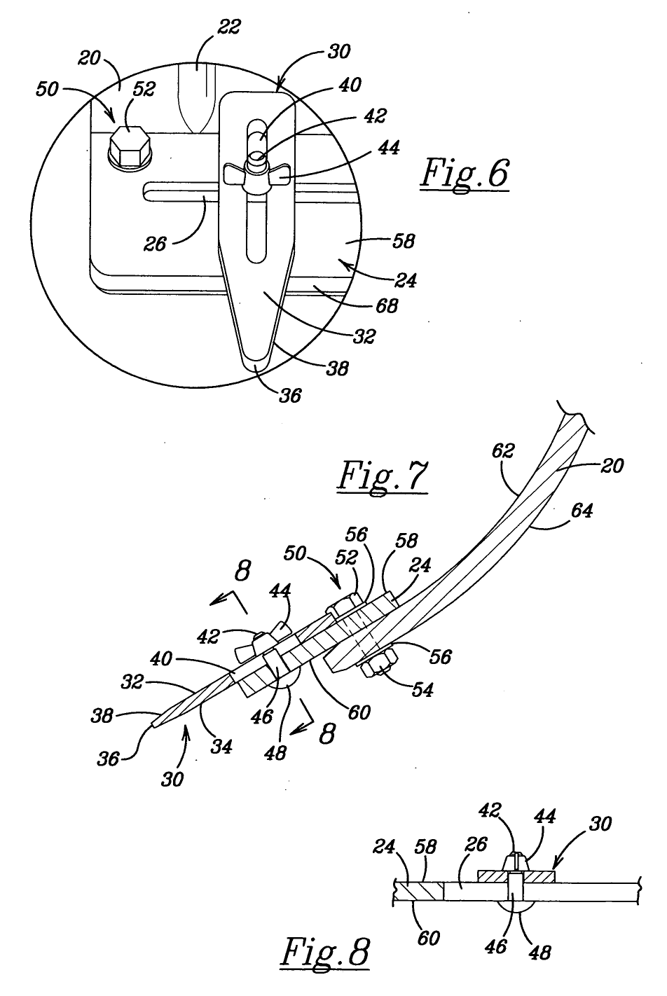

The shape of the teeth 30 shown in the accompanying figures is representative only. As illustrated in FIGS. 1-6, 9 and 10, the cleaning sides 38 of each tooth taper toward a rounded tip 36 at the distal first end thereof, to accommodate inwardly tapering recessed corrugations 72 in corrugated flooring 70. However, some floors 70 feature channels or troughs 72 less tapered or not tapered at all, and therefore teeth 30 having a squared-off or rectangular end 36a and nearly squared-off sides that may be more desired. Additionally or alternatively, the teeth 30 may have sidewardly extending scraper surfaces that may be added to either the tapered or squared-off sides 38 and/or the tips 36, 36a of any of the teeth 30 in order to facilitate the cleaning from the recessed channels or troughs 72 of any mash or debris resulting from the transport and/or storage of fungible goods loads. Further, the tips 36, 36a and/or the sides 38 of a tooth 30 may be shaped to a chisel point in order to facilitate the scraping of ice or other debris from the surfaces of the recessed corrugations 72 in a corrugated floor 70.

The reversed of tooth 30 with tip 36a is shown more clearly in FIG. 9 where the squared-off or rectangular end 36a extends outward from the blade 20 and edge plate 24. Tooth 30 is oriented perpendicularly to the edge plate 24, the blade 20 and the slot 26, and is retained in that orientation by the squared sides of the slot 26 in the edge plate 24, the squared slot 40 in the tooth 30 and the squared cross-section of the carriage bolt 42 attaching them together. As shown, the tooth 30 is fully extended with the edge 36a protruding to provide a broader aspect for clearing away debris from substantially flat surfaces such as the corrugation joints 74, the uncorrugated sections of the floor 70 abutting the container walls 78, and flat bottoms 88 of the corrugated recesses 72 that are wider than the width of a single tooth 30.

With reference to FIG. 10, one example of a wider bottom 88 of a corrugation 72 is shown in which two teeth 30 are necessary to be positioned for the proper cleaning of the recess. In this instance, one of the teeth 30 is positioned with the tapered tip 36 downward and positioned against the recess side 86 to be better able to clean the side of the recess 72 and a limited portion of the bottom 88. The second, adjacent tooth 30 is positioned with the rectangular tip 36a downward to accommodate the flat bottom 88 width of the recess 72 in the corrugated floor 70. Also shown reversed are the teeth 30 that overlie the joint 74 and the flat section of flooring 70 abutting the wall 78 of the container. In this manner, the pusher apparatus 10 can clear away the debris, i.e., mash, more quickly, as the teeth 30 are convertible to correspond closely to the irregular shape of the corrugated floor 70.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A hand manipulable apparatus for cleaning a corrugated surface of the type having essentially straight and parallel channels and ridges wherein the channels and ridges may be unevenly spaced apart across the corrugated surface and may be of irregular widths and depths, said device comprising:
a generally planar blade having a distal working edge, a proximal edge opposed thereto, and a pair of opposed side edges interconnecting between said distal edge and said proximal edge, said blade additionally having a front side and a rear side;
an elongate handle;
means for attaching said handle to extend outwardly from near the proximal edge of said blade in a generally coplanar relationship therewith;
a plurality of elongate tooth-like cleaning members each having a generally centrally disposed rectangular receiving means therethrough adapted for mounting each of said cleaning members to said blade, each of said plurality of cleaning members having a first and second end for use in cleaning said corrugated surface;
one or more generally rectangular slots disposed near the distal edge of said blade and parallel thereto, said slots extending through said blade from the front side to the rear side thereof and a plurality of means for non-rotatably attaching each of said cleaning members to extend outwardly from the distal edge of said blade in a generally coplanar relationship therewith, each of said cleaning member attaching means being captured in said receiving means of one of said cleaning members and further being captured in one of said rectangular slots of said blade, each of said cleaning member attaching means being adapted to be repeatedly loosened and tightened to enable each said cleaning member to be individually slidably repositioned along one of said rectangular slots in said blade parallel to the distal edge thereof;
each said plurality of cleaning members being independently slidably repositionable, with respect to each other, to an unlimited number of positions laterally within the rectangular slots along the distal edge of said blade, to be individually slidably repositioned along the rectangular receiving means thereof perpendicular to the distal edge of said blade to an unlimited number of extended positions relative to the distal edge of said blade, and to be individually reversible to present either the first or second ends thereof for cleaning the corrugated surface; and,
each of said plurality of cleaning members being fully retractable so that an individual cleaning member does not extend beyond the distal edge of said blade, enabling said apparatus to clean a section of said corrugated surface having recessed channels or troughs of varying depths or a section of a surface having no such channels or troughs.

2. The apparatus of claim 1, wherein said blade is curved to increase retention of debris during use to push the debris from a corrugated surface, whereby the front side of said blade is concave and the rear side of said blade is convex.

3. The apparatus of claim 1, wherein said blade further comprising an opposed pair of generally planar sidewalls extending frontwardly from approximately the side edges thereof and spanning from approximately the proximal edge to approximately the distal edge thereof, and disposed perpendicularly thereto.

4. The apparatus of claim 1, wherein at least one of said cleaning members includes symmetrically tapered sides transitioning from a relatively wider proximal base to a relatively narrower first end or tip, enabling said device to clean corrugated surfaces having channels or troughs that taper from relatively wider tops to relatively narrower bottoms.

5. The apparatus of claim 1, wherein at least one of said cleaning members has a second end or tip of a generally rectangular shape enabling said device to clean corrugated surfaces that are substantially flat or ones having generally straight-sided channels.

6. The apparatus of claim 1, wherein at least one of said cleaning members has a generally rectangular shape with a proximal base and a distal tip of relatively the same proportions, enabling said device to clean corrugated surfaces that are substantially flat or ones having generally straight-sided channels.

7. The apparatus of claim 1, wherein at least one of said cleaning members includes chisel-pointed sides and a chisel-pointed tip to enable said device to clean ice from a corrugated surface.

8. A shovel-like apparatus for cleaning a corrugated surface having essentially parallel channels and ridges, said channels and ridges may be non-uniformly spaced across the corrugated surface and be of varying depths, and may include sections without channels, comprising:
a generally planar blade having a distal working edge, a proximal edge opposed thereto, and a pair of opposed side edges interconnecting between said distal edge and said proximal edge, said blade optionally being curved to have a convex front side and a concave rear side, said blade further optionally having an opposed pair of generally planar sidewalls extending frontwardly from approximately the side edges thereof, spanning from approximately the proximal edge to approximately the distal edge thereof, and disposed perpendicularly thereto;
an elongate handle;
means for attaching said handle to extend outwardly from near the proximal edge of said blade in a generally coplanar relationship therewith;
a plurality of elongate tooth-like cleaning members each having a generally centrally disposed longitudinally extending slotted receiving means therethrough adapted for mounting each of said cleaning members to said blade;
one or more generally rectangular slots disposed near the distal edge of said blade and parallel thereto, said slots extending through said blade from the front side to the rear side thereof and a plurality of means for non-rotatably attaching each of said cleaning members to extend outwardly from the distal edge of said blade in a generally coplanar relationship therewith, each of said cleaning member attaching means being captured in said slotted receiving means of one of said cleaning members and further being captured in one of said rectangular slots of said blade;
each of said plurality of cleaning member attaching means being adapted to be repeatedly loosened and tightened to enable each of said plurality of cleaning members to be individually slidably laterally repositioned along one of said rectangular slots in said blade parallel to the distal edge of said blade, the loosening and tightening of said cleaning member attaching means additionally enabling each of said plurality of cleaning members to be individually slidably repositioned along the longitudinally slotted receiving means thereof perpendicular to the distal edge of said blade, the loosening and tightening of said cleaning member attaching means additionally enabling each of said plurality of cleaning members to be individually reversed in its position to expose a second end or tip for use in cleaning; and,
each said cleaning member being independently repositionable to an unlimited number of positions along and relative to the distal edge of said blade including a fully retracted position such that said cleaning member does not extend beyond the distal edge of said blade enabling said apparatus to clean a section of said corrugated surface having recessed channels or troughs of varying depths or a section of a surface having no such channels or troughs.

9. The apparatus of claim 8, wherein at least one of said cleaning members includes symmetrically tapered sides transitioning from a relatively wider proximal base to a relatively narrower distal tip, enabling said device to clean corrugated surfaces having channels or troughs that taper from relatively wider tops to relatively narrower bottoms.

10. The apparatus of claim 8, wherein at least one of said cleaning members has a second end or tip of a generally rectangular shape enabling said device to clean corrugated surfaces that are substantially flat or ones having generally straight-sided channels.

11. The apparatus of claim 8, wherein at least one of said cleaning members has a generally rectangular shape with a proximal base and a distal tip of relatively the same proportions, enabling said device to clean corrugated surfaces that are substantially flat or ones having generally straight-sided channels or troughs.

12. The apparatus of claim 8, wherein at least one of said cleaning members includes chisel-pointed sides and a chisel-pointed tip to enable said device to clean ice from a corrugated surface.
